(19) United States
(12) Patent Application Publication
(10) Pub. No.: US 2010/0042291 A1
(43) Pub. Date: Feb. 18, 2010

(54) METHOD FOR CONTROLLING/REGULATING AN ELECTRONICALLY CONTROLLED DAMPING SYSTEM IN A CONVERTIBLE MOTOR VEHICLE

(75) Inventors: Hilmar Baier, Nackenheim (DE); Jens van Mahnen, Gross-Gerau (DE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/293,544

(22) PCT Filed: Mar. 19, 2007
(86) PCT No.: PCT/EP07/02419

§ 371 Date: Sep. 23, 2009

(30) Foreign Application Priority Data
Mar. 22, 2006 (DE) 10 2006 013 065.0

(51) Int. Cl. B60G 17/06

(52) U.S. Cl. 701/37

(57) ABSTRACT

A method is provided for regulating an electronically controlled damping system in a convertible motor vehicle with a vehicle roof that can be transferred into an open position and into a closed position. The damping system includes at least one vibration damper with an electronically controllable actuator for adjusting a damping force of the vibration damper on at least one wheel suspension of the vehicle and a control unit that is functionally connected to the actuator and serves for controlling/regulating the damping force of the controllable vibration damper. The method further includes, but not limited to controlling the damping force of the at least one controllable vibration damper is in at least partial dependence on the position of the vehicle roof.

### CROSS-REFERENCE TO RELATED APPLICATIONS

This application is a U.S. National-Stage entry under 35 U.S.C. §371 based on International Application No. PCT/EP2007002419, filed Mar. 19, 2007, which was published under PCT Article 21(2) and which claims priority to German Application No. 102006013065.0, filed Mar. 22, 2006, which are all hereby incorporated in their entirety by reference.

### TECHNICAL FIELD

The present invention pertains to the field of automotive engineering and, more precisely, to a method for controlling/regulating an electronically controlled damping system in a convertible motor vehicle.

### BACKGROUND

Electronically controlled damping systems frequently are already installed as standard equipment in modern motor vehicles and serve for controlling the damping force of controllable vibration dampers (for example, MacPherson strut units) on the wheel suspensions.

An electronically controlled damping system usually comprises a multitude of sensors that are arranged on the vehicle body and serve for determining movements of the vehicle body that is usually assumed to be a rigid plate relative to the chassis. Additional sensors that are usually arranged on the vibration dampers themselves serve for determining the acceleration of the vehicle wheels. In order to realize a control of the damping system that is adapted to a particular driving situation in the best possible fashion, other sensors are usually also provided in order to determine, for example, the vehicle speed, the lateral acceleration of the vehicle (e.g., by utilizing a steering angle sensor) and the change of the lateral acceleration of the vehicle (e.g., by utilizing a steering angle jump sensor). In this case, the various sensors transmit the acquired data to a control unit of the damping system that, in turn, is functionally connected to actuators of the controllable vibration dampers. Control values for the actuators of the vibration dampers are usually determined in the control unit based on the sensor data as part of a characteristic diagram control and transmitted to the actuators in order to achieve a desired damping characteristic (damping force) of the vibration dampers on the wheel suspensions.

At least one objective of any controlled vehicle damping system consists of influencing the vibration characteristics of a vehicle body (i.e., the way in which the vehicle body moves relative to the chassis due to the influence of the roadway (uneven road surface) in a desired fashion.

It is known that the roof of convertible motor vehicles can be manually or automatically transferred into an open position and a closed position. For example, modern motor vehicles are frequently equipped with a folding roof that consists of several roof segments (or a so-called “retractable hardtop”), in which the roof segments are folded on top of one another in the open position of the vehicle roof and the stack of segments can be stowed, for example, in the trunk or behind the back seats.

With respect to convertible motor vehicles, it is also known that the driving dynamics of the vehicle change depending on whether the vehicle roof is in its open position or in its closed position. The main reasons for this variability of the driving dynamics are the changed torsional rigidity of the vehicle body, as well as a shift of the vehicle masses that is caused by the changed position of the vehicle roof and results in a shift of the center of gravity of the vehicle in its longitudinal and vertical direction. For example, the center of gravity of the vehicle is shifted in the direction toward the rear of the vehicle when the vehicle roof is opened while the center of gravity of the vehicle is shifted toward the front of the vehicle when the vehicle roof is closed.

Until now, such a change in the driving dynamics of a convertible motor vehicle was not taken into consideration in the damping characteristics of the vibration dampers of the electronically controlled damping system, and this may disadvantageously affect the driving comfort and the driving safety.

Consequently, at least one objective exists to make available a method for controlling/regulating an electronically controlled damping system in a convertible motor vehicle that makes it possible to at least reduce and preferably eliminate the above-described disadvantages. In addition, other objectives, desirable features, and characteristics will become apparent from the subsequent summary and detailed description and the appended claims, taken in conjunction with the accompanying drawings and this background.

### SUMMARY

According to an embodiment of the invention, this at least one objective, other objectives, desirable features, and characteristics are attained with a method for controlling/regulating an electronically controllable damping system having a first vibration damper configured to adjust a damping force of the first vibration damper of a first wheel of a vehicle. The damping system is in a convertible motor vehicle with a vehicle roof that can be transferred into a first position (e.g., an open position) and into a second (e.g., closed position). The method includes, but is not limited to the steps of receiving a signal that describes whether the vehicle roof has transferred into at least one of the first position and the second position and evaluating the signal. The method further includes, but is not limited to adjusting the damping force of the at least one controllable first vibration damper based at least in part is controlled/regulated in dependence on at least one of the first position and the second position of the vehicle roof determined with the evaluation of the signal.

According to another embodiment of the invention, the at least one objective, other objectives, desirable features, and characteristics are attained with a system configured to adjust a damping force for a first wheel of a vehicle in a convertible motor vehicle with a vehicle roof that can be transferred into a first position (e.g., open position) and into a second position (e.g., closed position). The system includes, but is not limited to a sensor configured to generate a signal that describes whether the vehicle roof has transferred into at least one of the first position and the second position, a control unit configured to receive the signal and generate a control signal for adjusting the damping force based at least in part on at least one of the first position and the second position of the vehicle roof determined with the evaluation of the signal, and a first vibration damper configured to receive the control signal and adjust the damping force for the first wheel of the vehicle.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

At least one embodiment of the invention proposes a method for controlling/regulating an electronically controlled damping system in a convertible motor vehicle and an electronically controlled damping system for implementing this method, respectively.

The electronically controlled damping system comprises at least one electronically controllable vibration damper (e.g., in the form of a MacPherson strut unit) with an electronically controllable actuator for adjusting the damping force of the controllable vibration damper. The damping force of the vibration damper may be expressed, for example, in the form of a harder or softer damping characteristic of the vibration damper. The vibration damper is arranged on a wheel suspension of the vehicle, wherein electronically controllable vibration dampers are generally provided on each wheel suspension of the vehicle.

The electronically controlled damping system furthermore comprises a control unit that is functionally connected to the actuators of the vibration dampers and serves for controlling/regulating the damping characteristics of the controllable vibration dampers, wherein correcting variables can be transmitted from the control unit to the actuators of the vibration dampers for this purpose.

In addition, it would be possible to provide (for example, two) wheel acceleration sensors on each vibration damper (for example, MacPherson strut unit) or stub axle and (for example, three) acceleration sensors on the vehicle body in order to transmit respective acceleration data to the control unit. This embodiment of the damping system may furthermore be provided with other sensors for determining a vehicle speed, a lateral acceleration of the vehicle (e.g., by utilizing a steering angle sensor) and a change of the lateral acceleration of the vehicle (e.g., by utilizing a steering angle jump sensor).

In accordance with an embodiment, the method for controlling an electronically controlled damping system of the above-described type in a convertible motor vehicle is provides for controlling the damping force of the at least one controllable vibration damper in dependence on (with consideration of) the position of the vehicle roof, particularly its open position and closed position. This makes it possible to take into consideration a change of the driving dynamics of the convertible motor vehicle caused by the changed position of the vehicle roof, namely by adapting the damping force of the at least one vibration damper. A suitable adaptation of the vehicle damping makes it possible, in particular, to counteract a change of the driving dynamics of the convertible motor vehicle caused by transferring the vehicle roof back and forth between its open position and its closed position.

In one advantageous embodiment of the invention, the damping force of the at least one controllable vibration damper is controlled/regulated by means of a data signal that is present in a general data bus of the vehicle (e.g., a “Controller Area Network (CAN) Data Bus”) and describes the open or closed state of the vehicle roof. In this context and in the following description, the term “general data bus” refers, in accordance with the general understanding of experts in this technical field, to a data bus that interconnects the different control units, if applicable, of different control systems such as, for example, the anti-locking system and the electronic stability control system, the sensors and the actuators in a convertible motor vehicle.

In modern motor vehicles with a manually or automatically actuated folding roof that consists of several roof segments, for example, in the form of a so-called retractable hardtop, the data signal that describes the open or closed position of the folding roof generally is already available in the data bus such that this data signal merely needs to be fed to the control unit of the electronically controlled damping system and evaluated therein.

The damping force of the at least one controllable vibration damper of the electronically controlled damping system may be controlled/regulated, for example, by means of a sensor signal of a sensor for determining the open or closed position of the vehicle roof that describes the open or closed state of the vehicle roof. In this case, the sensor signal may be fed to the general data bus of the convertible motor vehicle that, in turn, feeds the sensor signal to the control unit of the electronically controlled damping system. Alternatively, the sensor signal may be fed to the control unit of the electronically controlled damping system separately and evaluated therein.

In another exemplary embodiment of the method, the damping force of the controllable vibration damper may be controlled/regulated by means of the sensor signal of a sensor for determining the control position of a control means such as, for example, a manually actuated switch for controlling the opening or closing movement of the vehicle roof, wherein the sensor signal describes the open or closed state of the vehicle roof. In this case, the sensor signal can be fed to the general data bus of the convertible motor vehicle that, in turn, feeds the sensor signal to the control unit of the electronically controlled damping system. Alternatively, the sensor signal may be fed to the control unit of the electronically controlled damping system separately and evaluated therein.

It would be possible, in principle, to connect a control unit of an automatically actuated folding roof to the control unit of the controlled damping system, for example, via the general data bus such that a data signal describing the open or closed state of the folding roof can be fed to the control unit of the electronically controlled damping system and evaluated therein.

In the exemplary embodiment of the method, the damping force of the at least one controllable vibration damper may be controlled/regulated in the form of a relative change of the damping force of the vibration damper. If several controllable vibration dampers are provided, the damping force may be changed collectively or individually for each wheel.

Nevertheless, it is also possible to merely realize a relative change of the damping force distribution between the vibration dampers on the front axle and the rear axle of the vehicle in order to thusly counteract a shift of the center of gravity of the vehicle in its longitudinal direction.

It is furthermore possible to uniformly change the damping force of all vibration dampers by a selectable relative amount.

The damping force of the vibration dampers of the electronically controllable damping system can be changed in dependence on the open or closed position of the vehicle roof as part of a characteristic diagram control of the control unit of the damping system, namely in such a way that different characteristic diagrams are selected for the open and the closed position of the vehicle roof.

An exemplary embodiment of the invention also includes a control unit of an electronically controlled damping system in a convertible motor vehicle of the above-described type that is suitable for controlling/regulating the damping force of the at least one controllable vibration damper in dependence on the open or closed position of the vehicle roof.

An exemplary embodiment of the invention furthermore includes an electronically controlled damping system in a convertible motor vehicle with a control unit of the above-described type.

An exemplary embodiment of the invention furthermore includes a convertible motor vehicle with an electronically controlled damping system of the above-described type.

An exemplary embodiment of the invention furthermore includes a program code for an above-described control unit of an electronically controlled damping system in a convertible motor vehicle of the above-described type that is suitable for carrying out data processing tasks, wherein the program code contains control commands that cause the control unit to carry out an above-described method for controlling/regulating the electronically controlled damping system.

An exemplary embodiment of the invention furthermore includes a storage medium with a program code of the above-described type stored thereon.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit scope, applicability, or configuration of the invention. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents.

1. A method for regulating controlled damping system having a first vibration damper configured to adjust a damping force of the first vibration damper of a first wheel of a vehicle, the controlled damping system in a convertible motor vehicle with a vehicle roof that can be transferred into a first position and into a second position, comprising the steps of:
receiving a signal that describes whether the vehicle roof has transferred into at least one of the first position and the second position;
evaluating the signal; and
adjusting the damping force of the first vibration damper based at least in part on at least one of the first position and the second position of the vehicle roof determined with the evaluating of the signal.

2. (canceled)

3. The method according to claim 1,
wherein signal is a data signal transmitted in a general data bus of the vehicle.

4. The method according to claim 1,
wherein the signal is produced by a sensor configured to determine at least one of the first position and the second position of the vehicle roof.

5. The method according to claim 1,
wherein the signal is produced by a sensor configured to determine a control position of a controller configured to control a movement of the vehicle roof.

6. The method according to claim 1,
further comprising the step of adjusting a damping force of a second vibration damper based at least in part on at least one of the first position and the second position of the vehicle roof determined with the evaluating of the signal.

7. The method according to claim,
further comprising the steps of:
associating the first vibration damper and the first wheel with a first axle;
associating the second vibration damper and a second wheel with a second axle;
adjusting a relative change of a damping force distribution between the first vibration damper associated with the first axle and the second vibration damper associated with the second axle.

8. A system configured to adjust a damping force for a first wheel of a vehicle in a convertible motor vehicle with a vehicle roof that can be transferred into a first position and into a second position, comprising:
a sensor configured to generate a signal that describes whether the vehicle roof has transferred into at least one of the first position and the second position;
a control unit configured to receive the signal and generate a control signal for adjusting the damping force based at least in part on at least one of the first position and the second position of the vehicle roof determined with an evaluation of the signal; and
a first vibration damper configured to receive the control signal and adjust the damping force for the first wheel of the vehicle.

9-12. (canceled)

13. The system according to claim 8, wherein the signal is a data signal present in a general data bus of the vehicle.

14. The system according to claim 8, further comprising a second vibration damper configured to receive the control signal and adjust the damping force for a second wheel of the vehicle based at least in part on at least one of the first position and the second position of the vehicle roof determined with the evaluation of the signal.

15. The system according to claim 14, further comprising:
a first axle associated with the first vibration damper and the first wheel; and
a second axle associated with the second vibration damper and a second wheel,
wherein a relative change of a damping force distribution is adjusted between the first vibration damper associated with the first axle and the second vibration damper associated with the second axle.
